(19) United States
(12) Patent Application Publication
(10) Pub. No.: US 2012/0324139 A1
(43) Pub. Date: Dec. 20, 2012

(54) WIRELESS COMMUNICATION FOR POINT-TO-POINT SERIAL LINK PROTOCOL

(75) Inventor: Stephen D. Glaser, San Francisco, CA (US)

(73) Assignee: ADVANCED MICRO DEVICES, INC., Sunnyvale, CA (US)

(21) Appl. No.: 13/159,868

(22) Filed: Jun. 14, 2011

(51) Int. Cl. G06F 13/20; G06F 13/36

(52) U.S. Cl. 710/312; 710/313

(57) ABSTRACT

A wireless communication link, such as a PCIe endpoint-to-endpoint communication link, can be configured as a link in the communication protocol hierarchy, such that the wireless communication link is assigned its own bus identifier, and communications are routed to the wireless communication segment by a switch module based on the bus number. The wireless communication link can also be associated with the same link as a downstream wireless communication module. By employing the wireless communication segment as a link features of the communication protocol can be conventionally implemented by the host and downstream devices.

### BACKGROUND

1. Field of the Disclosure

The present disclosure generally relates to data processing systems and more particularly to point-to-point communication in data processing systems.

2. Description of the Related Art

Wireless communication of information has become increasingly common in a wide variety of areas, including telephone networks, computer networks, and the like. Wireless communication provides for communication devices that give users flexibility and portability. These features are also desirable for communication of information between data processing devices and peripheral equipment. However, conventional data processing devices and associated peripheral modules typically employ communication protocols that assume a wired communication infrastructure. Inserting a wireless segment into the communication infrastructure can be difficult due to a variety of factors. For example, some wired communication protocols, such as the Peripheral Component Interconnect Express (PCIe) protocol, implement a number of optional features that can be difficult to implement with a wireless segment.

### BRIEF DESCRIPTION OF THE DRAWINGS

The present disclosure may be better understood, and its numerous features and advantages made apparent to those skilled in the art by referencing the accompanying drawings.

FIG. 1 is block diagram illustrating data processing system in accordance with one embodiment of the present disclosure.

FIG. 2 is a block diagram illustrating a data processing system in accordance with another embodiment of the present disclosure.

FIG. 3 is a flow diagram illustrating communication of PCIe packets with the data processing system of FIG. 1.

FIG. 4 is a flow diagram illustrating communication of PCIe packets with the data processing system of FIG. 2.

The use of the same reference symbols in different drawings indicates similar or identical items.

### DETAILED DESCRIPTION

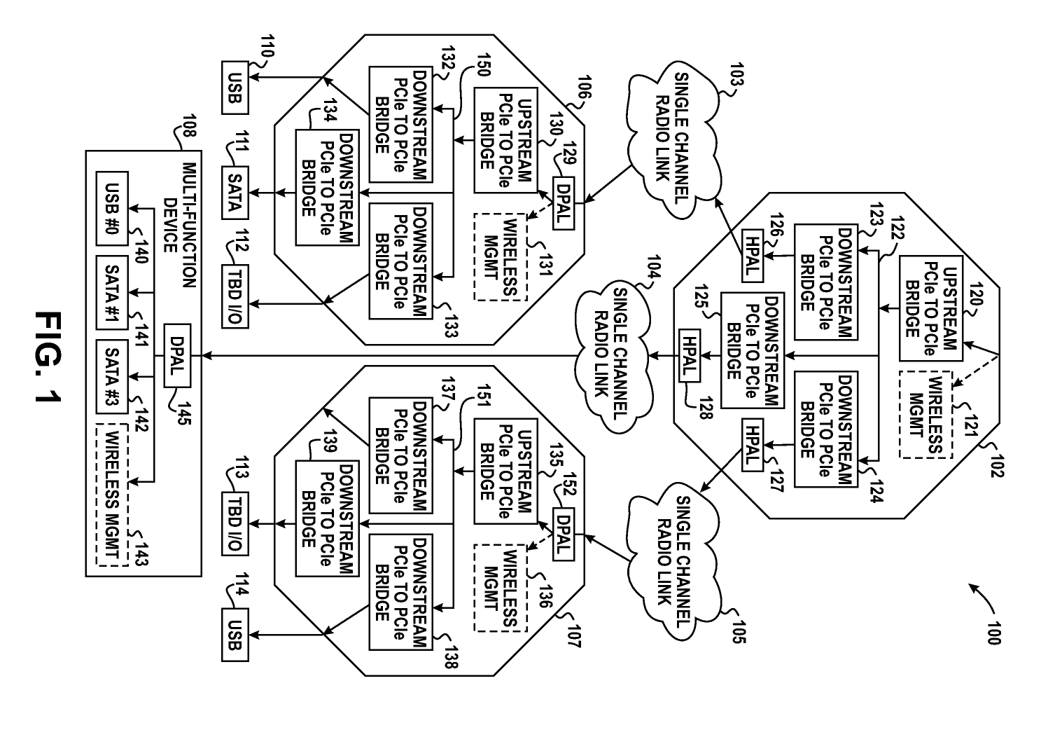

FIGS. 1-4 illustrate devices and techniques for including a wireless segment in a point-to-point serial communication link, such as a PCIe endpoint-to-endpoint communication link. In particular, the wireless communication link can be configured as a link in the communication protocol hierarchy, such that the wireless communication link is assigned its own bus identifier, and communications are routed to the wireless communication segment by a switch module based on the bus number. The wireless communication link can also be associated with the same link as a downstream wireless communication module.

To illustrate, conventional wireless PCIe communication can be implemented by employing a wireless communication segment as a portion of a PCIe switch. However, because the PCIe specification does not govern internal switch communication, but instead governs PCIe communication between PCIe switches, it can be difficult to implement optional PCIe features with the conventional approach. Further, as downstream devices are added or removed from a data processing system (by, for example, the devices moving into and out of wireless communication range), the conventional system can have difficulty managing PCIe sticky bits, hardware initialization fields, and other PCIe management features. In contrast, by associating the wireless segment with its own PCIe link, the wireless communication segment can leverage existing or future PCIe infrastructure to implement the optional PCIe features and manage the addition and removal of downstream devices according to the PCIe protocol.

FIG. 1 illustrates a data processing system 100 in accordance with one embodiment of the present disclosure. The data processing system 100 includes a host interface 102, PCIe wireless switches 106 and 107, interfaces 110-114, and multi-function device 108. The host interface 102 is an interface to a data processing device (not shown) that employs a data processor, memory interconnect, graphics processor, and other devices to execute computer program instructions. Interfaces 110-114 are interfaces to peripheral devices (not shown) such as disk drives, flash memory devices, media playback devices, and the like. In the course of executing computer program instructions, information is communicated between the host interface 102 and the interfaces 110-114 according to a point-to-point serial communication protocol, such as the PCIe protocol.

To illustrate, in an embodiment the host interface 102 is an interface for a general purpose processor and interface 110 is a universal serial bus (USB) interface that provides an interface to a media player. The host interface 102 can transfer media files, configuration instructions, and other information to the interface 110 by communicating information according to the PCIe protocol. Similarly, the interface 110 can transfer status information, media files, and other information to the host interface 102 according to the PCIe protocol.

Transfer of information between the host interface 102, the multifunction device 108, and the interfaces 110-114 is generally governed according to a point-to-point serial communication protocol. A point-to-point serial communication protocol can be a communication protocol for a set of point-to-point links connecting a root complex to a set of devices or device functions, whereby each point-to-point link can employ serial communication. In an embodiment, the point-to-point serial communication protocol is configured to emulate communications associated with a different communication topology, such as a shared bus topology. For purposes of discussion, it is assumed that the particular point-to-point serial communication protocol that governs communication for the data processing system 100 is the PCIe protocol. Accordingly, the data processing system 100 governs communication between PCIe ports by establishing a set of address spaces, including a configuration space, a memory space, and an input/output space. The configuration space indicates a unique set of identifiers for each device function in the system. Each set of identifiers can include a bus identifier (referred to as a bus number), a device identifier, and a function identifier. Thus, software executing at the host interface 102 can transfer information to one of the interfaces 110-114, or to a function of the multi-function device 108, by addressing the target of the information according to its set of identifiers. The memory space and input/output space can use the same, similar, or different identifiers. Similarly, the interfaces 110-114 (or devices connected thereto) and functions of the multifunction device 108 can transfer information to the host interface 102 by addressing the host interface 102 according to its set of identifiers. In an embodiment, the interfaces 110-114 address the host interface 102 according to a set of identifiers associated with memory space rather than configuration space. Communication from the host interface 102 to one of the interfaces 110-114 or to the multifunction device 108 is referred to as downstream communication, while communication in the opposite direction is referred to as upstream communication.

In the illustrated embodiment, the data processing system 100 employs a number of wireless links, designated wireless links 103-105, to facilitate communication with the interfaces 110-112, the multifunction device 108, and the interfaces 113 and 114, respectively. As described further herein, the data processing system 100 can assign each of the wireless links 103-105 its own set of identifiers, such as a unique bus identifier. In particular, the functions at each end of the links 103-105 will be assigned an identification number, while the wireless links 103-105 will each be assigned different bus numbers. Accordingly, each wireless link is therefore a distinct PCIe link. This allows for the addition or removal of wireless links, and therefore the addition or removal of the devices connected via the wireless links, to be governed according to the standard PCIe Hot-Plug protocol. In particular, the PCIe protocol includes specified procedures and behavior when a system changes at a link boundary, but may not include such procedures and behavior for changes to a system at other boundaries. Accordingly, by setting each wireless link as its own PCIe link, changes in the system that take place wireless link boundary can be addressed according to the specified procedures and behavior.

The PCIe wireless switches 106 and 107 are each configured to route received information according to the PCIe protocol. Accordingly, PCIe wireless switches each include a wireless interface (designated 129 and 152, respectively), an upstream bridge (designate 130 and 135, respectively), respectively, an internal bus (designated 150 and 151, respectively), and downstream bridges (designated 132, 133, and 134, and 137, 138, and 139, respectively). Each of the downstream bridges is connected to a corresponding input/output port of the corresponding PCIe wireless switch. Further, each of the upstream and downstream bridges is connected to the corresponding internal bus. Each upstream bridge is connected to the corresponding wireless communication module for the PCIe wireless switch.

In operation, each bridge can route PCIe communications to the other bridges of the corresponding switch via the internal bus. The routing along the internal bus can be governed by a protocol other than PCIe or other point-to-point serial protocol. Accordingly, each bridge can convert PCIe communications to the communication format associated with the internal bus. Further, for information received via the internal bus, each bridge can determine, based on routing information within the communication, if the information is targeted to the input/output port associated with the bridge. If the information is targeted to the associated input/output port, the bridge can translate the information to the PCIe format and provide the translated information to the associated port or wireless interface.

The wireless interfaces 129 and 152 each provide a physical layer interface between the corresponding wireless link and upstream bridge. Thus, wireless interfaces 129 and 152 can translate information received from the corresponding wireless link into PCIe formatted information for provision to the corresponding upstream bridge. Further, the wireless interface modules can translate information received from the corresponding upstream bridge to a wireless format for provision via the corresponding wireless link.

Host device 102 includes an upstream bridge 120, downstream bridges 123-125, and internal bus 122. The bridges and internal bus are configured to operate similarly to the corresponding modules of the PCIe switches 106 and 107. Each of the downstream bridges is connected to a corresponding wireless interface, designated 126-128, respectively. Each of the wireless interfaces 126-128 provides a physical layer interface for the corresponding downstream bridge to send and receive communications wirelessly.

The upstream bridge 120 is connected to a PCIe root complex (not shown) that can send and receive PCIe communications from a host processor or other device. For received ID-routed PCIe communications, the upstream bridge analyzes the set of identifiers associated with the communication to determine if any downstream elements are associated with the information. In particular, each downstream element will be associated with a bus number. The upstream bridge 120 can store information indicating the bus numbers of the downstream elements, and provide communications targeted to those bus numbers via the internal bus 122. Similarly, each of the downstream bridges 123-125 can store information indicating the bus numbers of downstream elements. Each of the downstream bridges communicates, via the associated wireless interface, only those PCIe communications targeted to elements downstream of the particular downstream bridge. Thus, for example, downstream bridge 123 will provide communications targeted to interfaces 110-112, but will not provide communications targeted to multifunction device 108 or to interfaces 113 and 114.

The multifunction device 108 includes functional modules 140-143 and a wireless interface 145. The wireless interface 145 provides a physical layer interface for the functional modules 140-143. Each of the functional modules 140-142 provides a PCIe interface for an associated device. Functional modules 140-143 differ from interfaces 110-114 in the way they are configured in the configuration space. In particular, the functional modules 140-143 share a common bus number, but have different function identifiers. In contrast, the interfaces 110-114 are each identified by a different bus number, and may also have different function identifiers.

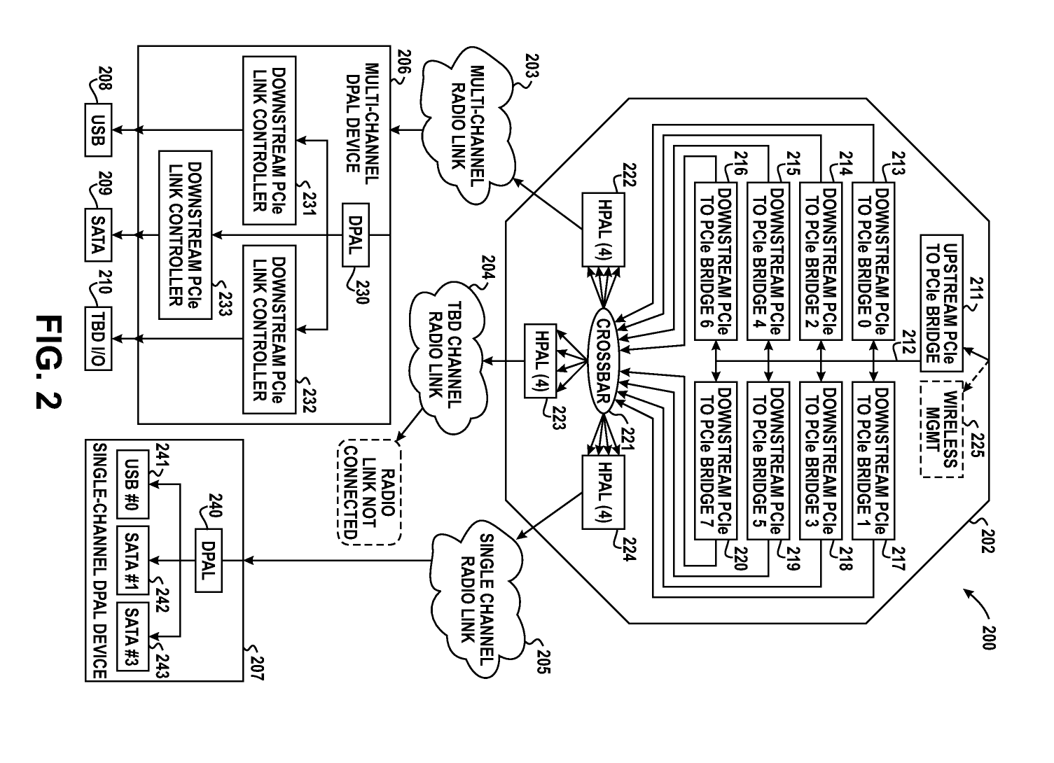

FIG. 2 illustrates a data processing system 200 in accordance with another embodiment of the present disclosure. Data processing system 200 includes a host interface 202, wireless links 203-205, downstream devices 206 and 207, and interfaces 208-210. In the illustrated embodiment, each wireless link can includes one or more channels. As used herein, a channel designates a set of information that can be separated from information communicated via another channel, such that each channel provides a different virtual connection between the devices communicating via the link. Accordingly, different channels can be associated with different carrier frequencies, different modulation schemes, different timeslots in a wireless communication frame, different values for fields in a message and the like. Different channels can have different transmission characteristics, such as different latencies, bandwidth, and the like. Each channel is associated with a unique PCIe link, and therefore being assigned a unique set of identifiers in the configuration space.

To illustrate, the host interface 102 includes an upstream bridge 211, an internal bus 212, downstream bridges 213-220, a crossbar switch 221, wireless interfaces 222-224, and wireless management module 225. The upstream bridge includes an input/output port connected to a root complex (not shown) and an input/output port connected to the bus 212. Each of the downstream bridges 213-220 is connected to the bus 212 and is connected to the crossbar switch 221. Each of the wireless interfaces 222-224 includes one or more connections to the crossbar switch 221, whereby each connection is associated with a different wireless channel. In the illustrated embodiment, each of the wireless interfaces includes four connections to the crossbar switch 221. It will be appreciated that the wireless interfaces 222-224 could each support a different number of wireless channels, and therefore have a different number of connections to the crossbar switch 221.

In operation, the crossbar switch 221 provides for the downstream connection of any of the downstream bridges 213-220 to be assigned to any wireless channel of any of the wireless links 203-205. Accordingly, when a device establishes a wireless link with the host interface 102, one or more of the downstream bridges 213-220 is connected to the device via one or more corresponding wireless channels.

To illustrate, multichannel device 206 includes a wireless interface 230 connected to downstream PCIe link controllers 231-233. Each of the PCI link controllers 231-233 is connected to a corresponding one of the interfaces 208-210. Each of the PCI link controllers 231-233 is configured to provide received PCIe communications to the associated interface. In an embodiment, one or more of the PCIe controllers 231-233 can support link splitting, so that the PCIe controller can support multiple simultaneous links. In this embodiment, the data processing system 202 can include additional downstream PCIe link controllers so that there is a 1:1 relationship between downstream bridges and a link controller. In the event that a link is not split, one or more of the downstream link controllers can be unused.

In operation, each of the interfaces 208-210 can be associated with a different PCIe link. Accordingly, the host interface 202 assigns a different one of the downstream PCIe bridges 213-220 to each PCIe link. Further, the wireless interface 222 configures the channels of the wireless link 203 so that each channel is associated with a different one of the PCIe links. The assigned downstream PCIe bridges are therefore each associated with a different wireless channel. The host interface 202 uses the management module 225 to control the crossbar switch 221 so that the downstream PCIe bridge associated with a wireless channel is connected to the input of the wireless interface 222 connected to that channel.

In addition, the host interface 202 sets the configuration space so that each of the wireless channels of the wireless link 203 is assigned a different set of identifiers, such as different bus identifiers. Communications can thereby be routed between the host interface 202 and the interfaces 208-210 using the PCIe protocol. In an embodiment, the bus numbers are assigned according to the PCIe protocol using the downstream bridge secondary bus number register (not shown) at downstream bridges 213-220. Wireless channel numbers are assigned by wireless management module 225 and by a management module (not shown) at downstream device 206. The downstream management module can be a PCIe function, or can be configured as part of the PCIe function associated with wireless management module 225.

In an embodiment, each of the downstream PCIe bridges 213-220 supports a different PCIe link configuration. For example, different ones of the downstream PCIe bridges 213-220 can support different communication speeds, communication bandwidths, hot-plug options, other PCIe options, and the like, or any combination thereof. When a downstream device, such as multichannel device 206, establishes a wireless link with the host interface 202, the downstream device and the host interface 202 can exchange information to indicate the PCIe link configuration supported by the downstream device. In response, the host interface 202 can determine whether there is a downstream bridge that supports the indicated PCIe link information available to be assigned to the PCIe link with the downstream device and, if so, assigns the determined downstream bridge to the PCIe link. If no downstream bridge that supports the indicated PCIe link configuration, the host interface 202 can assign a PCIe downstream bridge that supports the lowest common denominator of features between the downstream device and the host interface 202.

The single-channel device 207 includes a wireless interface 240 connected via a bus to interfaces 241-243. Each of the interfaces 241-243 can be associated with a different PCIe function identifier. Accordingly, each of the interfaces 241-243 can be associated with a single PCIe link. The wireless link 205 can be a single channel link that is assigned its own bus identifier in configuration space. Accordingly, single channel device 207 provides multiple functions via a single radio channel.

In other embodiments, a device can be associated with N+M PCIe links such that N PCIe links are associated with only one interface or other device, while M PCIe links are associated with multiple devices. In this configuration, the associated wireless link would include N+M channels, each channel associated with a different PCIe link and having its own set of identifiers in configuration space.

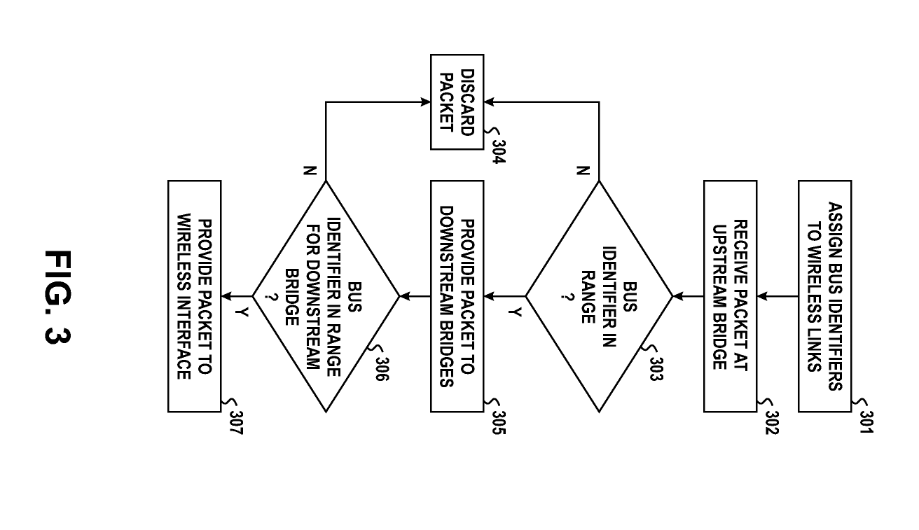

FIG. 3 illustrates a flow diagram of a method of communicating ID-routed PCIe packets according to the data processing system 100 of FIG. 1. At block 301, bus identifiers are assigned to each wireless channel at the data processing system 100. At block 302, the upstream bridge 120 receives an ID-routed PCIe packet. At block 303, the upstream bridge 120 determines whether the bus identifier of the packet is within the range of downstream bus identifiers for the upstream bridge 120, including those bus identifiers associated with the wireless channels. If not, the upstream bridge 120 discards the packet at block 304. Depending on the bus number associated with the packet, an error can also be signaled in one or more functions as set forth in the PCIe specification. If the bus identifier is within the range, the method flow moves to block 305 and the packet is provided to the downstream bridges 123-125. At block 306, each of the downstream bridges 123-125 determines if the bus identifier is addressed to one of the downstream bridge 123-125 or if it is within the range of bus identifiers for elements downstream of the corresponding downstream bridge. If not, the downstream bridge discards the packet at block 304. If the bus identifier is within the range for a particular downstream bridge, at block 306 that downstream bridge provides the packet to the corresponding wireless interface for conversion and communication via the corresponding wireless channel.

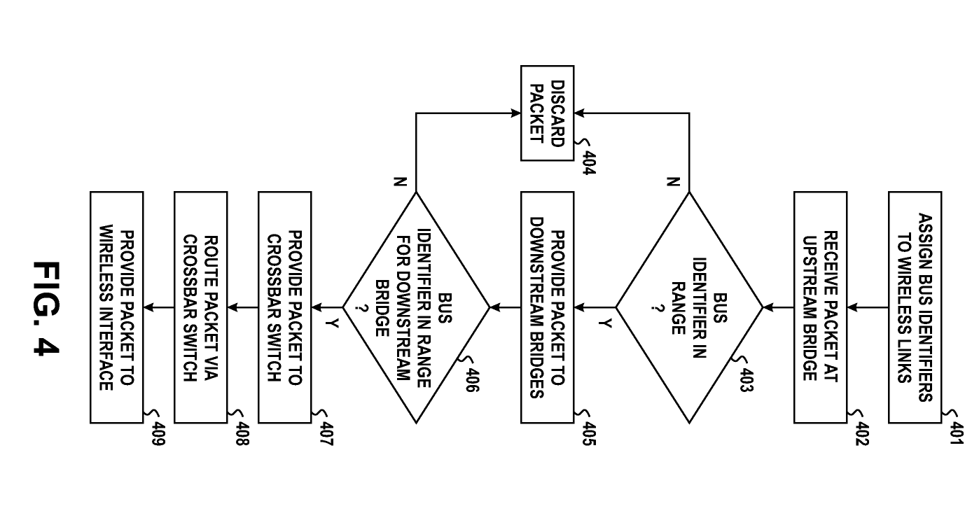

FIG. 4 illustrates a flow diagram of a method of communicating ID-routed PCIe packets according to the data processing system 200 of FIG. 2. At block 401, bus identifiers are assigned to each wireless channel at the data processing system 200. At block 402, the upstream bridge 211 receives an ID-routed PCIe packet. At block 403, the upstream bridge 120 determines whether the bus identifier of the packet is within the range of downstream bus identifiers 213-220, including those bus identifiers associated with the wireless channels. If not, the upstream bridge 211 discards the packet at block 404. Depending on the bus number associated with the packet, an error can also be signaled in one or more functions as set forth in the PCIe specification. If the bus identifier is within the range, the method flow moves to block 405 and the packet is provided to the downstream bridges 213-220. At block 406, each of the downstream bridges 213-220 determines if the bus identifier is within the range of bus identifiers for elements downstream of the corresponding downstream bridge. If not, the downstream bridge discards the packet at block 404 and can also, depending on the packet bus number, signal an error as set forth in the PCIe specification. If the bus identifier is within the range for a particular downstream bridge, at block 306 that downstream bridge provides the packet to the crossbar switch 221 at block 407. At block 408, the crossbar switch 221 routes the packet such that the packet is provided to a selected one of the wireless interfaces 222-224 for conversion and communication via the wireless channel indicated by the packet's bus number.

Note that not all of the activities or elements described above in the general description are required, that a portion of a specific activity or device may not be required, and that one or more further activities may be performed, or elements included, in addition to those described. For example, the data processing system 100, in addition to routing packets based on bus identifiers (referred to as ID routing), can also route packets according to other information. For example, in an embodiment, the data processing system 100 can route packets according to any routing information identified in the PCIe protocol. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
selecting, based on a first bus identifier of first packet, a first wireless communication channel of a plurality of wireless communication channels, the first packet configured according to a point-to-point serial interface protocol;
communicating the first packet via the first wireless communication channel.

2. The method of claim 1, wherein the point-to-point serial interface protocol comprises a Peripheral Component Interconnect Express (PCIe) protocol.

3. The method of claim 1, further comprising routing the first packet to a wireless interface associated with the first wireless communication channel via a crossbar switch.

4. The method of claim 1, further comprising:
receiving at the switch module a second packet comprising a second bus identifier, the second packet configured according to the point-to-point serial interface protocol;
selecting a second wireless communication channel of the plurality of wireless communication channels based on the second bus identifier;
communicating the second packet via the second wireless communication channel.

5. The method of claim 4, wherein the first wireless communication channel and the second wireless communication channel are associated with a common radio link.

6. The method of claim 1, wherein the first packet further comprises a function identifier that identifies a destination of the first packet.

7. The method of claim 1, wherein selecting the first wireless communication channel comprises selecting the first wireless communication channel in response to determining the first bus identifier is within a range of bus identifiers.

8. The method of claim 1, wherein:
receiving the first packet comprises receiving the first packet at a first bridge module of the switch module and providing the first packet to a plurality of downstream bridge modules; and
selecting the first wireless communication channel comprises selecting the first wireless communication channel at a first downstream bridge module of the plurality of downstream bridge modules and discarding the packet at a second downstream bridge module of the plurality of downstream bridge modules.

9. The method of claim 1, further comprising assigning the first bus identifier to the first wireless communication channel and assigning a second bus identifier to a second wireless communication channel.

10. A device, comprising:
a first switch module to receive a first packet comprising a first bus identifier, the first packet configured according to a point-to-point serial interface protocol, the switch module to route the first packet to a first output port of a plurality of output ports based on the first bus identifier, each of the plurality of output ports identified by a corresponding bus identifier; and
a first wireless interface coupled to the first output port, the first wireless interface to convert the first packet to a wireless communication format and communicate the converted first packet wirelessly.

11. The device of claim 10, wherein the switch module is to route a second packet comprising a second bus identifier to a second output port, and further comprising:
a second wireless interface coupled to the second output port, the second wireless interface to convert the second packet to a wireless communication format and communicate the converted second packet wirelessly.

12. The device of claim 11, wherein the first wireless interface communicates the converted first packet via a first wireless channel and the second wireless interface communicates the converted second packet via a second wireless channel.

13. The device of claim 12, wherein the first wireless channel and the second wireless channel are associated with a common wireless link to a second switch module.

14. The device of claim 10, wherein the first switch module comprises:
a first bridge module to receive the first packet;
a second bridge module coupled to the first bridge module, the first bridge module to route the first packet to the second bridge module based on the first bus identifier.

15. The device of claim 14, wherein the first bridge module is to route the first packet to the second bridge module based on the first bus identifier being within a first range of bus identifiers.

16. The device of claim 15, wherein the second bridge module is to provide the first packet to the first wireless interface based on the first bus identifier being within a second range of bus identifiers.

17. The device of claim 14, further comprising a crossbar switch coupled between the second bridge module and the first wireless interface.

18. A device, comprising:
an input port to receive a first packet via a wireless link, the wireless link uniquely associated with one or more bus identifiers in a point-to-point serial interface configuration space that indicates identifiers for a plurality of device functions; and
a wireless communication module to convert the first packet to a second packet configured for communication via a point-to-point serial interface protocol.

19. The device of claim 18, wherein the second packet comprises a bus identifier, and further comprising:
a switch module coupled to the wireless communication module to route the second packet to one of a plurality of output ports based on the bus identifier.

20. The device of claim 18, wherein the second packet comprises a bus identifier and a function identifier, and further comprising:
a plurality of functional modules, the functional modules to accept the second packet for communication based on the function identifier.
